(19) United States
(12) Patent Application Publication
(10) Pub. No.: US 2005/0032962 A1
(43) Pub. Date: Feb. 10, 2005

(54) Resin moldings having relatively low coefficients of expansion and composite products thereof

(75) Inventors: Hiroyuki Yamasa, Obu-shi (JP); Hiroyuki Taki, Obu-shi (JP)

Correspondence Address: OLIFF & BERRIDGE, PLC, P.O. BOX 19928, ALEXANDRIA, VA, 22320, US

(73) Assignee: TOKAI KOGYO CO., LTD., Obu-shi (JP)

(21) Appl. No.: 10/939,380

(22) Filed: Sep. 14, 2004

Related U.S. Application Data
(62) Division of application No. 10/211,577, filed on Aug. 5, 2002.

(30) Foreign Application Priority Data
Aug. 7, 2001 (JP) 2001-239315

(51) Int. Cl. C08K 3/04; C08K 3/34

(52) U.S. Cl. 524/451; 524/495

(57) ABSTRACT

Resin moldings are taught that have relatively low coefficients of linear expansion. For example, resin moldings may primarily comprise a polypropylene resin and/or an olefin-based thermoplastic elastomer. Composite products (10) may include at least two integrated resin-molded parts (12, 14, 16, and 18) whose compositions are different from each other, and at least one resin-molded part (18) may be comprised primarily of a polypropylene resin or olefin-based thermoplastic elastomer. The resin molding or at least one resin-molded part preferably contains a fibrous filler, which preferably comprises primarily carbon fibers, at a weight percentage of between about 1 and 10% and a powder filler (e.g., talc) at a weight percentage of between about 0 and 50%. The fibrous filler and the powder filler preferably serve as expansion/contraction suppression components for the resin material.

This application claims priority to Japanese Patent Application No. 2001-239315, filed on Aug. 7, 2001, and U.S. patent application Ser. No. 10/211,577, filed on Aug. 5, 2002, the contents of which are hereby incorporated by reference herein.

### BACKGROUND OF THE INVENTION

1. Field of the Invention

The present teachings relate to resin moldings and to composite products that include resin moldings, and more particularly to resin moldings and composite products that possess excellent dimensional stability against temperature changes.

2. Description of the Related Art

Resin products comprised of synthetic resin materials will expand and contract as temperature changes according to their coefficients of linear expansion. Consequently, in some cases, resin products cannot retain their predetermined shape or installation state when subjected to temperature changes, thereby resulting in deformation (twisting, wrinkling, etc.) or shifting (dislocation, warping, etc.) from their installation position. These characteristics of resin products are especially problematic for elongated resin products (e.g., elongated members, such as moldings for vehicles and joiners installed between the edges of adjacent building panels), because the external dimensions of elongated resin products are structurally more prone to significant changes due to such expansion and contraction.

Further, it is known that mixing talc into a resin can reduce the expansion and contraction of a resin product associated with temperature changes. However, if a relatively high percentage by weight of talc is introduced into the resin, the durability of the resulting resin product tends to be reduced, thereby making it impossible to provide other properties (e.g., shock resistance, etc.) that are required of the resin product. That is, if the expansion and contraction of a resin product are suppressed by simply adding talc, additional practical problems will result.

On the other hand, the coefficients of linear expansion of metals and inorganic materials are generally lower than the coefficients of linear expansion of resin materials. Therefore, it is known to embed a metallic core along the longitudinal direction or axis of an elongated resin product in order to prevent the resin product from excessively expanding and contracting in the longitudinal direction due to temperature changes. This technique is particularly commonly used in the field of vehicle moldings. However, because this technique increases the number of parts that are required to make the resin molding, manufacturing costs will be increased. Furthermore, because an additional step is necessary to make the metallic core, the manufacturing process is more complex. Additionally, because such products contain different types of materials, i.e., resins and metals, such resin moldings having a metal core cannot be easily disposed of or recycled.

Japanese Laid-Open Patent Publication No. 6-312620 discloses a technique for suppressing the expansion and contraction of a window molding for automobiles (elongated resin product) without the use of a metallic core. In particular, window moldings for automobiles are taught that include a main area (mold body) formed from a resin material having a coefficient of linear expansion of 5×10⁻⁵/° C. or less. This patent publication suggests the use of soft polyvinyl chloride (PVC) and olefin-based materials as resin materials having low coefficients of linear expansion (i.e., less than 5×10⁻⁵/° C.). However, it is not, in fact, practically possible to produce a resin molding (molded body) exhibiting such a low range of coefficient of linear expansion (i.e., less than 5×10⁻⁵/° C.) using such ordinary resin materials.

### SUMMARY OF THE INVENTION

Therefore, one object of the present teachings is to provide resin moldings having a relatively low coefficient of linear expansion (i.e., relatively low linear expansion rate). In one aspect of the present teachings, composite products are taught that include such a resin molding. In another aspect of the present teachings, elongated resin members, e.g., vehicle moldings, are taught that are suitable for installation along vehicle panels. In a further aspect of the present teachings, elongated resin members, e.g., joiners, are taught that are suitable for installation between the edges of building panels. Such elongated resin members preferably include resin moldings having a relatively low coefficient of linear expansion according to the present teachings.

In one embodiment of the present teachings, resin moldings may comprise a polypropylene resin or an olefin-based thermoplastic elastomer as the primary resin component of the resin molding. Such resin moldings also preferably contain a fibrous filler, which may primarily consist of carbon fibers, at a weight percentage of about 1 to 10% of the total weight of the resin molding. Further, such resin moldings also preferably contain a powder filler at a weight percentage of about 0 to 50% of the total weight of the resin molding.

In the present specification, the term “powder filler” is intended to mean an inorganic filler having a mean particle size of about 0.1 to 100 μm. Preferably, the powder filler has a mean particle size of about 0.5 to 50 μm. Preferable powder fillers can be prepared by grinding a silicate mineral (e.g., talc ore) in a grinder, pulverizing the grindings in a mill, followed by classification (separation) by means of a suitable classifier. Powderized inorganic fillers may have, e.g., a spherical shape, a flake shape or other crushed shapes. A flake-shaped inorganic filler, such as talc or mica, is especially preferable.

The fibrous (carbon) filler may be added to a matrix resin, which primarily comprises a polypropylene resin or olefin-based thermoplastic elastomer (hereafter referred to as “TPO”), as a component for improving dimensional stability. Hereinafter, compositions having such properties also may be referred to as “expansion/contraction suppression components.” More preferably, a powder filler is also added in addition to the fibrous filler. In such case, the resin molding will expand and contract less in response to temperature changes as compared to known resin moldings that do not contain an expansion/contraction suppression component. Therefore, improved dimensional stability can be obtained. Improvements in dimensional stability are especially noticeable when the resin molding has an elongated shape.

The powder filler (e.g., talc) may be added in order to further suppress expansion/contraction (i.e., further reduce the coefficient of linear expansion). If a fibrous filler is used as a primary ingredient, addition of the powder filler can prevent or suppress the degradation in physical characteristics (e.g., durability) of the resin molding. The content of the powder filler preferably may be 35% or less of the total weight of the resin molding. Further, the content of the fibrous filler preferably may be 2.5% or more of the total weight of the resin molding. Resin moldings having such a composition can advantageously combine the physical characteristics inherent in a matrix resin with dimensional stability (expansion/contraction suppression) against temperature changes.

The present resin moldings preferably exhibit a coefficient of linear expansion of about 5×10⁻⁵/° C. or less, and more preferably between about 1×10⁻⁵ and 5×10⁻⁵/° C. Even more preferably, the present resin moldings may have a coefficient of linear expansion of about 3×10⁻⁵/° C. or less, e.g., between about 1×10⁻⁵ and 3×10⁻⁵/° C. This range of coefficients of linear expansion is relatively close to the coefficients of linear expansion of both inorganic materials and ordinary metals (e.g., steel, aluminum, etc.). For example, the coefficient of linear expansion of iron (Fe) is about 1.4×10⁻⁵/° C. In other words, such a resin molding can exhibit nearly the same level of dimensional stability as a material that is primarily comprised of a metallic or an inorganic material. Therefore, such resin moldings can replace the metallic or inorganic material in applications (e.g., the core of a vehicle molding) in which metallic or inorganic materials have been previously utilized due to their low coefficients of linear expansion (i.e., low linear expansion rates).

Resin moldings exhibiting such a range of coefficients of linear expansion may be installed or disposed within (or proximal to) a host member primarily comprised of, e.g., a metallic or inorganic material. In this case, the difference in the coefficients of linear expansion (i.e., the difference in expansion and contraction associated with temperature changes) between the resin molding and the host member will be relatively small. As a result, it is possible to prevent excessive stress from being generated due to differences in expansion and contraction associated with temperature changes between the resin molding and the host member. Consequently, warping and deformation of the resin molding associated with temperature changes are less likely to occur. Therefore, such resin moldings may be advantageously utilized as a material for forming all or a part (e.g., a core) of a resin product that will be installed or disposed in a host member primarily comprised of a metallic or inorganic material. The effects of improved dimensional stability are especially noticeable when the resin product is elongated. Examples of such resin products include an elongated resin member that will be installed along a vehicle panel (e.g., various types of vehicle moldings) and an elongated resin member (e.g., a joiner) that will be installed between the edges of adjacent building panels (e.g., drywall).

In the present specification, the term “molding” is typically intended to mean a product formed by extrusion molding an elongated shape having a constant cross section, or by injection molding, etc., a predetermined three-dimensional shape. When combined (integrated) with another molding (molded body), the present resin moldings can be used as a core (expansion/contraction suppression core) for suppressing expansion and contraction associated with temperature changes. For example, the present resin moldings can be used in place of a metallic core in applications that previously utilized a metallic core embedded within a resin molding.

Composite products according to the present teachings preferably include at least two integrated resin-molded parts whose compositions are different from each other. For example, at least one first resin-molded part may primarily contain a polypropylene resin and/or TPO. The first resin-molded part also preferably contains a carbon fiber-based fibrous filler at a weight percentage of about 1 to 10% of the total weight of the resin-molded part. More preferably, the first resin-molded part also may contain, as an additive, a powder filler at a weight percentage of about 0 to 50% of the total of weight of the resin-molded part. A second resin-molded part may be adhered to, joined to, or fused with the first resin-molded part and the second resin-molded part may have a different composition from the first resin-molded part, as will be further discussed below.

Because at least two resin-molded parts are integrated (fused) in such composite products, the second resin-molded part is prevented from moving or displacing relative to the adjacent, first resin-molded part. Thus, in the case of an elongated composite product, longitudinal expansion and contraction of the first and second resin-molded parts will occur together. The first resin-molded part, which will typically have a lower coefficient of linear expansion, will thereby prevent the second resin-molded part from excessively expanding and contracting as the temperature changes. The at least two resin-molded parts (having different compositions) may be secured and integrated by chemical means (e.g., by fusion, adhesion, etc.) and/or by mechanical means (e.g., press-fitting, engagement, frictional resistance, etc.).

At least the first resin-molded part preferably has the composition of the above-described resin moldings. In this case, the first resin-molded part will exhibit excellent dimensional stability against temperature changes. If the present composite products are integrated with at least one of the first resin-molded parts (hereafter referred to as “low-expansion/contraction resin molded parts”), the dimensional stability of the overall composite product is superior to products that do not contain such a low-expansion/contraction resin molded part.

Such an effect has been well demonstrated when the composite product is elongated and two or more resin-molded parts are integrated along the longitudinal direction in an overlapping manner. That is, the elongated composite product experiences little longitudinal expansion and contraction associated with temperature changes and has excellent dimensional stability. The at least two resin-molded parts may both be the above-described low-expansion/contraction resin moldings, or may be a combination of the above-described low-expansion/contraction (first) resin molded part and a (second) resin-molded part that is not a low-expansion/contraction resin molded part (hereafter also referred to as “non-low-expansion/contraction resin molded part”). In the present specification, the term “non-low-expansion/contraction resin molded part” is intended to encompass a resin molded part whose composition is not included within the above-described “at least one of the above-described resin-molded parts,” and does not imply a limit on its expansion and contraction characteristics (coefficient of linear expansion, etc.).

One representative embodiment of such elongated composite products is a composite product in which the coefficients of linear expansion of the two or more resin-molded parts are different from each other. In such composite products, even when the coefficients of linear expansion (linear expansion rates) are different, the first resin-molded part (low-expansion/contraction resin molded part), which has the lower linear expansion rate, suppresses the expansion and contraction of the second resin-molded part, which has the higher linear expansion rate. As a result, the dimensional stability of the composite product as a whole can be maintained at a high level despite the presence of the second resin-molded part having the higher linear expansion rate. That is, in composite products of this representative embodiment, the above-described resin-molded part having the lower linear expansion rate functions as an expansion/contraction suppression core for the above-described resin-molded part having the higher linear expansion rate.

Preferred composite products possess a coefficient of linear expansion of 3×10⁻⁵/° C. or less, and more preferably between about 1×10⁻⁵ and 3×10⁻⁵/° C. for the above-described low-expansion/contraction resin molded part (at least one of the above-described resin-molded parts). A composite product integrally containing resin-molded parts having such low coefficients of linear expansion can exhibit a high degree of dimensional stability across a wide range of temperatures. If a composite product having such properties further includes a resin-molded part whose coefficient of linear expansion exceeds 3×10⁻⁵/° C. (e.g., between 3×10⁻⁵ and 1×10⁻⁴/° C.), expansion and contraction of the resin-molded part having the higher coefficient of linear expansion is suppressed by the low-expansion/contraction resin molded part, thereby remarkably improving the dimensional stability of the composite product. Preferred composite products have an overall coefficient of linear expansion of about 5×10⁻⁵/° C. or less (e.g., between about 1×10⁻⁵ and 5×10⁻⁵/° C.), and more preferably have a coefficient of linear expansion of about 3×10⁻⁵/° C. or less (e.g., between about 1×10⁻⁵ and 3×10⁻⁵/° C.). In the present composite products, the content, shape, location, etc., of the low-expansion/contraction resin molded part may be appropriately selected in order to provide such a coefficient of linear expansion.

One preferred application of the present composite products is an elongated member that is arranged and constructed for installation along a vehicle body panel, such as a vehicle body panel made of sheet metal. That is, the composite product is preferably formed as an elongated member for installation along a vehicle body panel (hereafter also referred to as an “elongated member for vehicles”). Representative examples include various vehicle moldings, such as roof moldings, window moldings, side molding, etc. Such elongated members for vehicles may contain two or more low-expansion/contraction resin molded parts, or may contain at least one low-expansion/contraction resin molded part and at least one non-low-expansion/contraction resin molded part. In order to achieve a good balance between dimensional stability and other desired performance characteristics (e.g., mountability onto the vehicle panel, appearance, etc.), it is preferable to integrate at least one low-expansion/contraction resin molded part with at least one non-low-expansion/contraction resin molded part that has a composition and/or shape suitable for achieving the necessary performance characteristics of the composite product.

In one representative elongated member for vehicles, the above-described low-expansion/contraction resin molded part can be positioned such that it cannot be seen from the outside when it is installed in a predetermined location on the vehicle body panel. For example, the low-expansion/contraction resin molded part can be positioned in a location where a metallic core was previously embedded within known vehicle moldings. In other words, in this representative elongated member for vehicles, the low-expansion/contraction resin molded part can be utilized as a replacement for a known metallic core. Furthermore, an elongated member for vehicles having a resin-molded part with a smooth surface is preferably provided in a location that can be seen from the outside when the member is installed in the predetermined location on the vehicle (e.g., on the product surface). In this case, both dimensional stability and excellent appearance (decorativeness) can be achieved. Further, the above-described resin-molded part having a smooth surface preferably does not contain a fibrous filler, because resin-molded parts that do not contain a fibrous filler typically have a better surface (product surface) flatness.

In another representative application of the present composite products, an elongated member may be installed or embedded between two or more adjacent building panels (hereafter referred to as an “elongated member for buildings”). For example, the composite product may be formed as an elongated member for installation between building panels. A representative example of such an elongated member is a joiner that is placed or disposed along a gap between the edges of adjacently positioned building panels.

The present resin moldings and composite products (e.g., elongated members for vehicles, elongated members for buildings, etc.) can suppress excessive expansion and contraction associated with temperature changes without the use of a metallic material, such as a metallic core. For example, a coefficient of linear expansion similar to those of metallic materials (steel, aluminum, etc.) or inorganic materials (concrete, etc.) can be achieved with a substantially resinous material. Therefore, the present resin moldings and composite products do not require a metallic material in order to suppress expansion and contraction or to achieve dimensional stability. During disposal or recycling, such a resin molding or composite product not containing a metallic material can be shredded or cut up without the need to separate the parts comprised of resins from the parts comprised of metallic materials. That is, excellent disposability or recyclability is provided. Furthermore, when processing (e.g., cutting) is necessary for the resin molding or composite product, an ordinary cutting tool can be used to cut the resin product, because it does not contain a metallic core. Further, the cutting tool will also last longer, because it is only necessary to cut a resin material (i.e., it is not necessary to also cut a metallic core). Additionally, composite products comprising a resin molding (as a replacement part for a metallic core) will not rust (become corroded) because such composite products do not contain any metallic material. Therefore, there is no need to be concerned about the problems that might be caused by the presence of a metallic member, e.g., mechanical failure of the metallic member, such as a metallic core, due to rusting or contamination of the product itself or its surrounding area by rust.

These aspects and features may be utilized singularly or in combination in order to provide improved resin molding materials and composite products thereof. In addition, other objects, features and advantages of the present teachings will be readily understood after reading the following detailed description together with the accompanying drawings and the claims. Of course, the additional features and aspects disclosed herein also may be utilized singularly or in combination with the above-described aspects and features.

### BRIEF DESCRIPTION OF THE DRAWINGS

FIG. 1 is a schematic diagram showing a representative manufacturing method for a composite product.

FIG. 2 is a schematic diagram showing another representative manufacturing method for a composite product.

FIG. 3 is a partial perspective cross-sectional diagram schematically showing a representative composite product, i.e., a roof molding for an automobile.

FIG. 4 is a partial perspective cross-sectional diagram schematically showing another representative composite product, i.e., a joiner.

FIG. 5 is a cross-sectional diagram schematically showing another representative composite product, i.e., another roof molding for an automobile.

### DETAILED DESCRIPTION OF THE INVENTION

Resin moldings according to the present teachings preferably have a composition in which a predetermined amount of fibrous filler (preferably a predetermined amount of powder filler as well) is added (as an expansion/contraction suppression component) to a matrix resin substantially comprised of a polypropylene resin and/or TPO.

Representative polypropylene resins appropriate for use with the present teachings include a propylene homopolymer or a copolymer of propylene and another α-olefin (e.g., one or more of ethylene, butene, hexene, heptene, etc.). The copolymer may be a block copolymer or a random copolymer of propylene and an α-olefin. Propylene homopolymer is particularly preferable due to its relatively low price, ease of procurement, thermal stability, etc.

Any type of olefin-based thermoplastic elastomer (TPO) may be appropriately used with the present teachings, including polymerization types (reactor type), blended types, statically cross-linked types, dynamically cross-linked types, etc. The olefin component (relatively hard (inelastic) component) of such a TPO may include polyethylene, polypropylene, poly-l-pentene, etc. Polyethylene and polypropylene are preferable and polypropylene is especially preferable. The elastomer component (rubber component or relatively soft (elastic) component) may include an ethylene-propylene copolymer (EPM), an ethylene-propylene-diene copolymer (EPDM), etc. EPDM is especially preferable. Two or more kinds of polymers may be used as the olefin components. Further, two or more types of olefin-based thermoplastic elastomers (TPO) may be utilized as the elastomer component. In the present teachings, a preferable TPO may include a relatively inelastic component consisting of polypropylene or a mixture of polypropylene and polyethylene and a relatively elastic component consisting of an ethylene-propylene rubber (EPM) or an ethylene-propylene-diene terpolymer (EPDM), in which the EPM and EPDM each may be partially or completely cross-linked. A more preferable TPO may include polypropylene as a relatively inelastic component and EPDM as a relatively elastic component (hereafter may also be referred to as “PP-EPDM-based TPO”). An especially preferable TPO may includes a relatively inelastic component consisting of polypropylene and having a bending modulus of elasticity of equal to or more than 100 MPa (more preferably at least 200 MPa).

Furthermore, the present resin moldings may contain both a polypropylene resin and TPO as the matrix resin. It is also possible to supplement and blend in one or more types of components in addition to the polypropylene resin and TPO within a range that does not significantly increase the coefficient of linear expansion of the resin molding (preferably at a weight percentage of 20% or less of the total weight of the entire matrix resin). Such supplemental components may include olefin-based resins in addition to polypropylene, such as high-density polyethylene (HDPE), medium-density polyethylene (MDPE), low-density polyethylene (LDPE), straight chain low-density polyethylene (LLDPE), and very low-density polyethylene (VLDPE); polybutene; ethylene-α-olefin copolymer; ethylene-vinyl acetate copolymer (EVA); rigid or soft polyvinyl chloride resin (PVC); ABS (acrylonitrile-butadiene-styrene) resin; polyvinyl alcohol, butadiene rubber; isoprene rubber; butyl rubber, fluoro rubber, etc. It is also possible to blend in a thermoplastic elastomer in addition to TPO. Such thermoplastic elastomers may include styrene-based thermoplastic elastomer (SBC), urethane-based thermoplastic elastomer (TPU), polyamide-based thermoplastic elastomer (TPAE), polyvinyl chloride-based thermoplastic elastomer (TPVC), etc.

The percentage of the resin material (resin matrix) is preferably between about 40 and 95% (more preferably between about 45 and 90%) of the total weight of the resin molding (final product). If the resin molding contains a powder filler as well as a fibrous filler, the percentage of the resin material (resin matrix) is preferably between about 45 and 70% of the total weight of the resin molding (final product).

The present resin moldings also preferably contain a fibrous filler, which may comprise carbon fibers as a primary component of the fibrous filler. Representative carbon fibers appropriate for use with the present teachings include PAN (polyacrylonitrile) or pitch-based carbon fiber. However, it is noted that the appropriate type should be selected based on factors such as raw material costs. It is also possible to use both the PAN and pitch types together. For example, suitable carbon fibers may possess a tensile strength of between about 600 and 6,000 MPa (preferably between about 3,000 and 4,500 MPa) and/or a linear modulus of elasticity of between about 30 and 1,000 GPa (preferably between about 200 and 950 GPa). Preferred shapes for the carbon fibers include an average fiber length of between about 0.2 and 50 mm (more preferably between about 3 and 15 mm) and/or a fiber diameter of between about 3 and 20 μm (more preferably between about 5 and 15 μm).

Commercially available products containing such carbon fibers include the following:

(a) PAN-based:

Pyrofil® TR066 and Pyrofil® TR06U made by Mitsubishi Rayon Co., Ltd.; Besfight™ HTA-C6-N and Besfight™ HTA-C6-S made by Toho Rayon Co., Ltd.; and Torayca® T008 made by Toray Industries, Inc., etc.

(b) Pitch-based:

Dialead® K223SE, Dialead® K223QG, and Dialead® K223HG made by Mitsubishi Chemical Products, Inc.; Donacarbo™ S-242 and Donacarbo™ S-343 made by Donac Co., Ltd.; Kreca™ C-106F and Kreca™ C-106S made by Kureha Chemical Industry Co., Ltd.; and Granoc™ XN-P9C and Granoc™ XN-60C made by Nippon Graphite Fiber Corp., etc.

The resin molding also may contain a supplemental fibrous filler preferably at a weight percentage of about 20% or less (e.g., between about 1 and 20%) of the total weight of the entire fibrous fillers (i.e., including the carbon fibers). Representative fibrous fillers appropriate for use with the present teachings include inorganic fibers, such as glass fibers, alumina fibers, silicon carbide fibers, and inorganic whiskers, such as, basic magnesium sulfate whiskers, potassium titanate whiskers, and aluminum borate whiskers. Further, organic fibers (e.g., aramid fibers) containing a material having a lower coefficient of linear expansion than the matrix resin also may be suitably utilized with the present teachings.

In addition, the present resin moldings also may contain a powder filler that serves as an additional expansion/contraction suppression component. Representative powder fillers appropriate for use with the present teachings include one or more types of materials selected from the following list: calcium carbonate, calcium silicate, carbon black, talc, clay, kaolin, silica, diatomaceous earth, mica powder, alumina, barium sulfate, aluminum sulfate, calcium sulfate, basic magnesium carbonate, molybdenum disulfide, glass bulbs, Shirasu balloons (hollow inorganic microspheres from a volcanic glass), etc. Talc, calcium carbonate, and silica are preferable, and talc is most preferable. The preferred average grain size of the powder filler (e.g., talc) is between about 0.5 and 25 μm. Powder fillers having an average grain size of between about 1 and 6 μm are especially suitable.

The above-described fibrous filler is preferably between about 1 and 10% of the total weight of the low-expansion/contraction resin molded part. If the fibrous filler comprises less than 1% of the total weight, its effect on increasing the dimensional stability of the resin molding will be negligible. On the other hand, if the fibrous filler comprises more than 10% of the total weight, the resin molding may become less moldable and raw material costs for the resin molding will be increased. The resin molding (low-expansion/contraction resin molded part) may further contain a powder filler at a weight percentage of 50% or less of the total weight of the low-expansion/contraction resin molded part. The percentage of the powder filler is preferably between about 5 and 50% of the total weight, and more preferably is within the range of about 10 and 35% of the total weight. If the powder filler comprises less than 5% of the total weight, its effect will be negligible. If the powder filler comprises more than 50% of the total weight, the durability, elasticity, etc. of the resin molding may be reduced.

If the resin molding (i.e., the low-expansion/contraction resin molded part) does not contain any powder filler, it is preferable to set the content of the fibrous filler in the resin molding to a value between about 2.5 and 10% of the total weight of the resin molding, and more preferably, between about 5 and 10% of the total weight of the resin molding. A resin molding having such a composition is preferable because it has sufficiently high dimensional stability without sacrificing the inherent durability or elasticity of the matrix resin. On the other hand, if the resin molding (i.e., the low-expansion/contraction resin molded part) also contains a powder filler, it is preferable to set the content of the fibrous filler in the resin molding to a value between about 1 and 5% of the total weight of the resin molding, and more preferably, between about 1 and 2.5% of the total weight of the resin molding. Because a resin molding having such a composition includes both a fibrous filler and a powder filler, a smaller volume (amount) of the fibrous filler may be utilized to obtain the same level of dimensional stability (coefficient of linear expansion), as compared to a case in which no powder filler is used. In this case, raw material costs for the resin molding may be reduced.

The resin molding (i.e., the low-expansion/contraction resin molded part) may contain one or more types of ordinary additives such as an antioxidant, light stabilizer, ultraviolet absorbing agent, plasticizer, lubricant, colorant, and/or flame retardant, in addition to the above-described matrix resin, fibrous filler, and powder filler. The total weight of these additives is preferably about 10% or less of the total weight of the resin molding (i.e., the low-expansion/contraction resin molded part).

There are no particular restrictions on the methods for manufacturing resin moldings according to the present teachings. For example, an ordinary extrusion molding method can be used to suitably manufacture resin moldings according to the present teachings. For example, when the resin molding is elongated (e.g., wire shape, tape shape, etc.) and has a constant cross-sectional shape, it is preferable to utilize extrusion molding as the manufacturing method. However, hot compression molding (e.g., injection molding) and other ordinary molding methods also can be used for manufacturing resin moldings according to the present teachings. For example, when the resin molding is manufactured by means of hot compression molding, the surface shape of the mold is imparted to the surface of the resin molding. Therefore, it is easy to produce a resin molding having a relatively smooth surface (excellent design characteristic) using hot compression molding techniques.

As representative, but non-limiting examples, the present resin moldings can be used as an elongated member for vehicles (e.g., a molding for a vehicle), or an elongated member for buildings (typically a joiner), etc. in the form of a resin product primarily consisting of the molding itself. The present resin moldings also may be suitable as a “core” for various products (e.g., composite products according to the present teachings) that are used in combination with other materials (e.g., resin materials), etc. The core can function as an expansion/contraction suppression core for suppressing expansion and contraction of an elongated resin product in which said core and other resin materials are integrated. For example, a core comprised of a resin molding according to the present teachings can be used as a replacement for known metallic cores (e.g., steel wire and band steel).

If the resin molding will be used as a core, the resin molding is preferably formed in a relatively thin, elongated shape, such as a wire shape, tape shape, etc. The transversal cross-sectional shape of this long resin molding is not limited in any way. Representative cross-sectional shapes include, but are not limited to, circular, oval, elliptical, polygonal (typically rectangular), V-shaped, L-shaped, U-shaped, and cross-shaped. Although there are no particular restrictions on the methods for manufacturing such a resin molding, extrusion molding is preferably used. If a resin molding manufactured by means of extrusion molding contains a fibrous filler, the surface of the resin molding tends to be rough. Such a resin molding (core) has a larger surface area for contacting and adhering (or fusing) to another resin material. Furthermore, the rough surface (irregular surface) tends to produce better mechanical adhesion (integration) and higher bonding strength, in addition to increasing the effective contact area with other resin materials. Therefore, such molding techniques are highly effective for preventing de-lamination (peeling) and expansion/contraction of other resin materials.

The present composite products may include two or more integrated resin-molded parts having mutually different compositions. One or more may be resin-molded parts (low-expansion/contraction resin molded parts) having the same composition as the above-described resin moldings (i.e., preferably including carbon fibers). If the composite product also contains a resin-molded part that is not a low-expansion/contraction resin molded part (i.e., a non-low-expansion/contraction resin molded part), there are no particular restrictions on the composition of the non-low-expansion/contraction resin molded part. Suitable compositions may be selected according to the application, etc. of the composite product. For example, if the composite product will be used as an elongated member for vehicles (e.g., a molding for vehicles) or an elongated member for buildings (e.g., a joiner), the resin material (matrix resin) for such a non-low-expansion/contraction resin molded part may be selected from the following: hard or soft polyvinyl chloride resin, ABS resin, olefin resin (typically polyethylene terephthalate (PET) resin), various types of thermoplastic elastomers (typically TPO resin or styrene-based thermoplastic elastomer (SBC)), etc., or appropriate blends of these resins. Furthermore, the non-low-expansion/contraction resin molded part may contain a fibrous filler and/or powder filler in addition to the above-described resins.

The two or more resin-molded parts are preferably integrated (joined) chemically by means of fusion bonding (fusing) or adhesion (gluing). In order to simplify the fusing or adhesion process, matrix resins comprising two or more resin-molded parts preferably possess compatibility with each other. For example, the matrix resins comprising the two or more resin-molded parts preferably use the same type of (e.g., identical) polymer as their main ingredients. Representative combinations of matrix resins comprising two or more resin-molded parts include, e.g., (1) a combination of an olefin resin (e.g., polypropylene) and a TPO containing the olefin resin, (2) a combination of two or more types of TPOs having different compositions in which the olefin (e.g., polypropylene) content varies and (3) a combination of two or more types of polyvinyl chloride resins (PVC) having different degrees of hardness. A compatibility-enhancing agent may be utilized in order to improve the compatibility of these matrix resins.

The coefficients of linear expansion of the two or more resin-molded parts may be different from each other. Methods for differentiating the coefficients of linear expansion of the two or more resin-molded parts from each other include varying the compositions and/or the composition ratio of the matrix resins, adding or not adding a filler (fibrous filler, powder filler, etc.), varying the type and/or content of the filler if used, etc.

The above-described low-expansion/contraction resin molded part is preferably located in a position that is not visible from the outside when the composite product has been installed (e.g., when installed in a vehicle panel in the case of a vehicle molding, or when installed between the edges of a building panel in the case of a joiner). If the composite product is installed in a position that is not visible from the outside during use, the low-expansion/contraction resin molded part may be disposed on the surface of the composite product. Because the low-expansion/contraction resin molded part typically does not contain any metallic material, it will not rust due to moisture, even if it is exposed on the surface of the composite product. However, a resin-molded part having a smooth surface is preferably positioned in a location of the composite product that is visible to the outside. Such composite products will have a high degree of dimensional stability, a smooth surface on the outside (product surface), and may be highly decorative. The above-described resin-molded part having a smooth surface is preferably a resin-molded part comprising a thermoplastic elastomer (typically TPO), etc. and not containing a fibrous filler. If a fibrous filler is used, this resin-molded part preferably may be manufactured by hot compression molding (e.g., injection molding).

If the composite product is elongated, the above-described low-expansion/contraction resin molded part preferably may be disposed or embedded along the longitudinal axis or direction of the composite product. For example, the elongated low-expansion/contraction resin molded part preferably may be continuously disposed along the entire length, or along substantially the entire length (e.g., at least 80% of the entire length), in the longitudinal direction of the composite product. The transversal cross-sectional shape of the low-expansion/contraction resin molded part is not limited in any way. Representative shapes include, e.g., circular, oval, elliptical, polygonal (typically rectangular), V-shaped, L-shaped, U-shaped, cross-shaped, etc. In such a configuration, the low-expansion/contraction resin molded part effectively suppresses the expansion and contraction of the entire composite product. In other words, composite products having such a configuration possess excellent dimensional stability along their longitudinal direction or axis.

In addition, by integrating a resin-molded part containing a fibrous filler (e.g., short fibers such as carbon fibers), etc., the bending modulus of elasticity of the composite product can be improved (i.e., add rigidity to the composite product) in the same way as an inserted metallic core. Consequently, elongated composite products, in particular, become less prone to unintended bending, etc., thereby resulting in improved handleability during manufacturing, storage, installation, etc.

The relative position of the low-expansion/contraction resin molded part within the transversal cross section (the cross section that is perpendicular to the longitudinal direction) of the composite product may remain constant or may change along the longitudinal direction of the composite product. Likewise, the cross-sectional shape and size of the low-expansion/contraction resin molded part within the transversal cross section of the composite product may remain constant or may change along the longitudinal direction of the composite product. For example, the low-expansion/contraction resin molded part may be thicker (i.e., have a larger cross-sectional area) in the linear portions of the elongated member and thinner (i.e., have a smaller cross-sectional area) in the bent portions.

There are no particular restrictions on the methods for manufacturing the present composite products. Representative examples include, e.g., (1) integrally forming a preformed resin-molded part (e.g., a low-expansion/contraction resin molded part) and resin materials comprising other resin-molded parts, (2) integrally forming the resin materials comprising the individual resin-molded parts simultaneously (so-called co-extrusion molding), and (3) separately forming the individual resin-molded parts beforehand and then integrating these components by fusing, adhesion, etc. The above-described Methods (1) and (2) are preferable.

A representative embodiment will now be explained that utilizes the above-described Method (1) in order to manufacture an elongated composite product having a low-expansion/contraction resin molded part integrated with a non-low-expansion/contraction resin molded part along the longitudinal direction of the composite product. For example, the resin material comprising the low-expansion/contraction resin molded part (e.g., a resin material that has a polypropylene resin as its main ingredient and contains predetermined amounts of fibrous filler and powder filler) may be first supplied to an extrusion die. The melted or softened resin material is extruded through the die to form an elongated shape (e.g., wire shape, tape shape, etc.) having a relatively simple cross section (e.g., round, square, etc.). Thus, a “core,” which is equivalent to the resin molding, may be produced by extrusion molding. Such a manufacturing method can extrusion-mold the core at high speeds because the transversal cross-sectional shape is simple. Naturally, a plurality of cores may be simultaneously extrusion-molded from a single extrusion die in order to increase productivity.

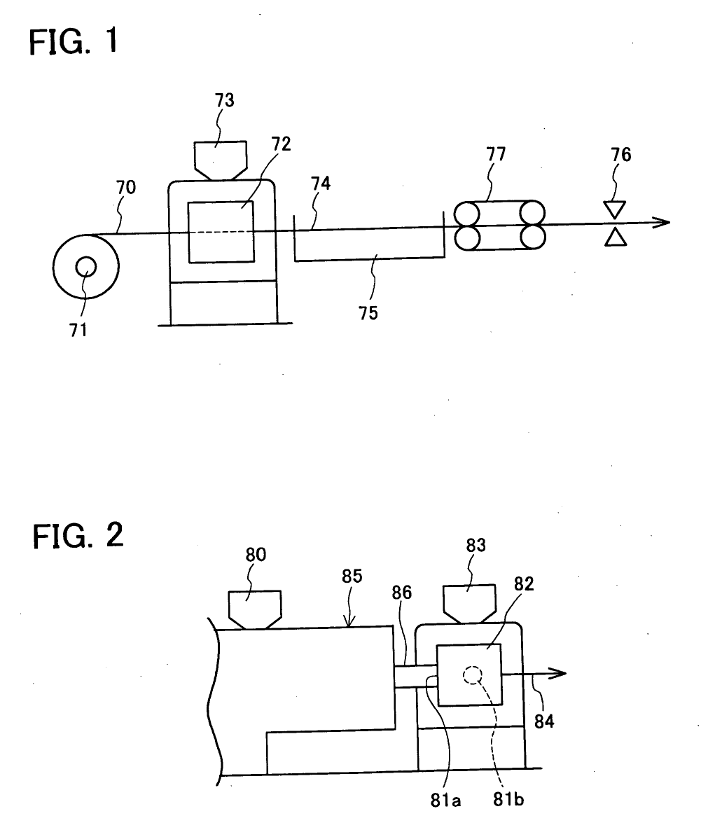

As shown in FIG. 1, a core 70, which corresponds to the low-expansion/contraction resin molded part, may be wound around a drum 71 or another similar device for storing the core 70. As the core 70 is being continuously supplied from the drum 71 to an extrusion die 72, a resin material 73 comprising the other resin-molded part (e.g., PP-EPDM-based TPO) is simultaneously supplied in a molten state from a supply port (not shown) to the extrusion die 72. Then, the preformed core 70 along with the resin material 73 comprising the other resin-molded part are extrusion-molded together from the extrusion die 72 with a predetermined transversal cross section. During the extrusion molding process, the surface of the core (low-expansion/contraction resin molded part) 70 typically melts due to heat. Thus, an elongated composite product 74 is formed and the core 70 is integrated (fused) with the other resin-molded part (the resin-molded part formed from the resin material 73) due to fusion bonding. The desired composite product can be obtained, e.g., by then cooling the composite product 74 in a cooling device 75, taking it up via a take-up device 77, and cutting it to the desired length using a cutting device 76. Such a manufacturing method is preferably used when the melting temperature of the low-expansion/contraction resin molded part is significantly different from the melting temperature of the non-low-expansion/contraction resin molded part.

Optionally, the surface of the core 70 that will be supplied to the extrusion die may be coated with an adhesive beforehand. In this case, adhesion between the low-expansion/contraction resin molded part and the non-low-expansion/contraction resin molded part can be improved. Such adhesive coating methods are especially effective when the low-expansion/contraction resin molded part and the non-low-expansion/contraction resin molded part have significantly differing solubility parameter values, or when the matrix resins comprising the two resin-molded parts are not very compatible with each other.

Further, in the above-described manufacturing method, a core that was extrusion-molded beforehand is taken up by a drum for storage and use. However, it is also possible to position a first extrusion die for forming the core in series with a second extrusion die for forming the composite product, such that a core is continuously formed by the first extrusion die and then is continuously supplied to the second extrusion die, as is. In this case, the cross-sectional shape of the core is not limited to simple shapes, and the core can be formed to have a complex heteromorphic cross section. Moreover, it is no longer necessary to store the core before it is used to form the composite product.

A representative embodiment will now be explained that utilizes the above-described Method (2) in order to manufacture a elongated composite product in which a low-expansion/contraction resin molded part is integrated with a non-low-expansion/contraction resin molded part along the longitudinal direction of the composite product. As shown in FIG. 2, an extrusion die 82 includes a first supply port 81a from which a resin material for forming a low-expansion/contraction resin molded part is supplied and a second supply port 81b from which the resin material for forming a non-low-expansion/contraction resin molded part is supplied. The resin material for the low-expansion/contraction resin molded part is placed into a hopper 80 and heated inside a cylinder 86 of an extrusion molding machine 85, and is then supplied in a molten state. The resin material for the non-low-expansion/contraction resin molded part is placed into a hopper 83, and similarly heated and supplied in a molten state. The resin materials supplied from the supply ports 81a and 81b into the extrusion die 82 are extruded from an extrusion opening (not shown) having a predetermined shape. In this way, a composite product 84 is extrusion-molded and the low-expansion/contraction resin molded part is integrated (fused) with the non-low-expansion/contraction resin molded part due to fusion bonding within the single extrusion die 82.

Naturally, a composite product can be obtained by first cooling the composite product 84, as was explained in the above-described Method (1), and then cutting it to the desired length. Such a manufacturing method can be appropriately implemented using a die in which the positions of the above-described first and/or second supply ports can be adjusted. For example, a die may be utilized in which the relative positions between the portion formed from one resin material and the portion formed from the other resin material can be varied along the longitudinal direction within the transversal cross section of the composite product that will be extruded. Further details concerning such a die are described, e.g., in U.S. patent application ser. No. 09/869,646 filed on Jul. 5, 2001 and which is incorporated herein by reference in its entirety.

The present composite products may be suitably utilized as an elongated member (elongated member for vehicles) for installation along a vehicle panel made of a metallic plate (e.g., made of steel or aluminum). Representative examples of such elongated members for vehicles include vehicle moldings, such as a roof molding that will be installed along the roof of a vehicle, a window molding that will be mounted along the edge of a window panel for a vehicle, side moldings that will be installed along the exterior surfaces of a door panel and a fender panel, outer and/or inner belt moldings that will be installed along the outside and/or the inside of the door panels along a gap between the top edge of the door and the door opening, and a pillar molding that will be installed along a pillar; glass run channels that will be installed along the window frame to guide the movement of the glass window; weather strip that will be installed along the edges of vehicle openings; and other types of decorative trim members.

As described above, expansion and contraction (especially changes in length) associated with temperature changes can be suppressed in such elongated members for vehicles. Further, because the difference in coefficients of linear expansion between the metallic vehicle panels and the elongated members is reduced or minimized, deformation (twisting, wrinkling, etc.) of the elongated members, shifting (dislocation, warping, etc.) from their installation positions due to a difference in coefficient of linear expansion, etc. are less likely to occur. Therefore, it is possible to eliminate or simplify the conventional complex structures that have been provided on vehicle panels and/or the elongated members in order to absorb the difference in coefficients of linear expansion. Furthermore, because the elongated members for vehicles can be designed so as not to contain any metallic members (e.g., cores), they can be easily disposed of or recycled.

A representative configuration for a representative composite product is an elongated member for vehicles (e.g., roof molding) having a low-expansion/contraction resin molded part that comprises a polypropylene resin and/or TPO as the matrix resin, and at least two non-low-expansion/contraction resin molded parts that comprise TPO (e.g., PP-EPDM-based thermoplastic elastomer) as main ingredients, but do not contain any fibrous filler. When the elongated member is installed along a vehicle panel, at least one of the above-described non-low-expansion/contraction resin molded parts is preferably disposed in a position that is visible from the outside (i.e., constituting the product surface). The above-described low-expansion/contraction resin molded part is preferably disposed in a position that is not visible from the outside.

Taking scratch resistance and luster into consideration, the non-low-expansion/contraction resin molded part comprising the product surface may preferably comprise a relatively rigid TPO (e.g., PP-EPDM-based TPO having a relatively high polypropylene content) or PVC as the main ingredient. Taking into consideration the ease of installation, etc., along vehicle panels, the other non-low-expansion/contraction resin molded parts may preferably comprise a relatively soft and elastic TPO (e.g., PP-EPDM-based TPO having a lower polypropylene content) as the main ingredient.

Other preferred applications of the present composite products include elongated members (e.g., elongated member for buildings) arranged and constructed for installation between building panels. Representative examples of such elongated members for buildings include an end rail and girt that will be positioned between exterior wall panels, a joiner for plugging or filling the gap between exterior wall panels, a floor molding for installation along the bottom edge of interior walls, furring strips, fascia boards, etc. Because these elongated members for buildings suffer little expansion and contraction (especially changes in length) associated with temperature changes, they are not likely to become deformed or to shift from their installation positions. Furthermore, because a composite product that does not contain a metallic member (e.g., core) can be used, no rusting occurs even when the composite product is exposed to the environment. Moreover, no special tools are required for installation, because ordinary tools, such as a pair of scissors, can be used to easily cut the present composite products at the desired locations. Therefore, the present composite products enable simple, on-site installation. Examples of other preferred applications of the present composite products include elongated members used in furniture, etc.

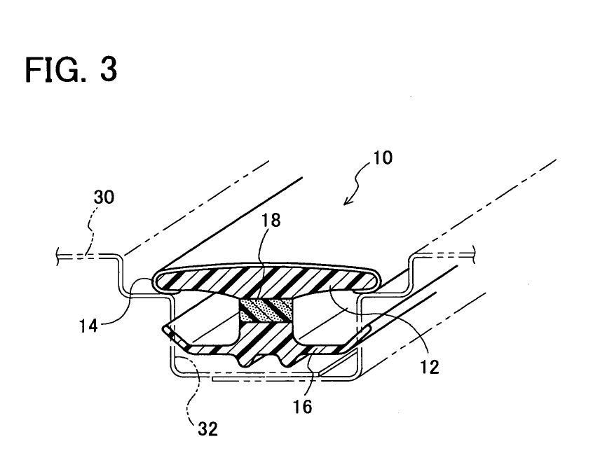

Another representative embodiment will be explained below in which the composite product is utilized as a roof molding for automobiles. As shown in FIG. 3, a roof molding 10 is press-fitted into a groove 32, which is defined within a metallic roof panel 30, so as to close or seal at least a part of the groove 32. The roof molding 10 includes four resin-molded parts: a head 12 designed to be received within or seal the groove 32, a decorative cover layer 14 provided on the surface of the head 12, thereby forming the product surface that is visible from the outside when installed (e.g., within the groove 32 in this embodiment), an engaging portion (legs) 16 that is press-fitted within the groove 32 and is pressed against the vehicle body in the installation location, and a core 18 that connects the head 12 to the engaging portion 16. The core 18 is band-shaped and has a nearly rectangular transversal cross section. Further, the core 18 is located in a position that is not visible from the outside when installed. These four resin-molded parts (the head 12, the decorative cover layer 14, the engaging portion 16, and the core 18) are positioned so as to overlap with each other (i.e., extend contiguously) along the longitudinal direction, and are mutually integrated (joined) by fusion bonding.

The head 12 and the engaging portion 16 preferably comprise primarily a relatively soft PP-EPDM-based TPO. The decorative cover layer 14 is preferably comprised primarily of a relatively rigid polypropylene resin or PP-EPDM-based TPO. The head 12, decorative cover layer 14, and engaging portion 16 may preferably contain no fibrous filler or powder filler (expansion/contraction suppression component). However, the core 18 is preferably primarily comprised of a polypropylene resin and/or PP-EPDM-based TPO and also contains a fibrous filler primarily comprising carbon fibers at a weight percentage of between about 1 and 10% of the total weight of the core 18 and a powder filler at a weight percentage of 50% or less of the total weight of the core 18. In other words, the core 18 may be a resin-molded part that is equivalent to a low-expansion/contraction resin molded part, which was described above in further detail.

The roof molding 10 is configured such that the core 18 serves as a predetermined expansion/contraction suppression component (e.g., having a relatively low coefficient of linear expansion: e.g., between about 1×10⁻⁵ and 3×10⁻⁵/° C.). Other resin-molded parts (i.e., not containing an expansion/contraction suppression component and having a greater coefficient of linear expansion than the core 18: e.g., greater than 3×10⁻⁵/° C.) are integrated together and overlap the core 18 along the longitudinal direction. Therefore, the core 18 suppresses the expansion and contraction of the other resin-molded parts associated with temperature changes. As a result, the coefficient of linear expansion of the entire roof molding 10 becomes less than when the above-described core is not used and can approach or be substantially the same as the coefficient of linear expansion of the metallic roof panel 30. Therefore, the roof molding 10 will not disengage from the roof panel 30 when the temperature changes, and can maintain itself appropriately installed along the roof panel 30 during use. Furthermore, because the roof molding 10 does not contain any metallic material, such as a metallic core, it can be easily disposed of or recycled. Additionally, because the presence of the core 18 adds some rigidity to the roof molding 10, installation is simplified.

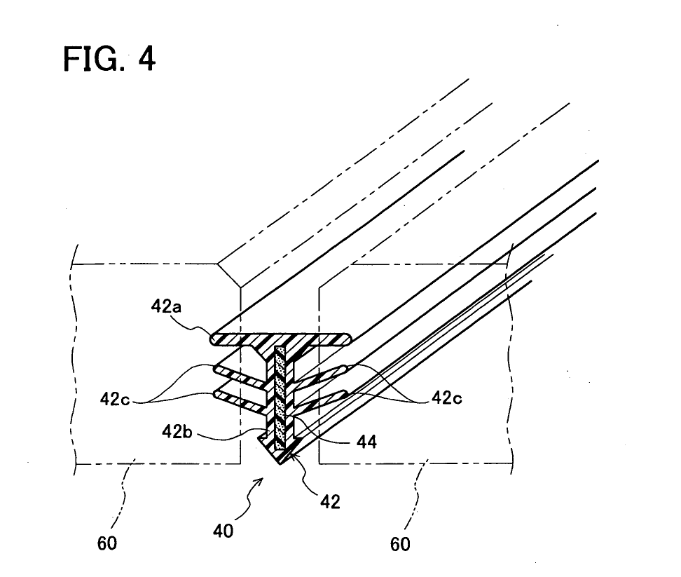

Next, another representative embodiment will be explained in which the composite product is utilized as a joiner for building panels. As shown in FIG. 4, an elongated joiner 40 is designed for press-fitting into a gap (joint) between two adjacent building panels 60. The joiner 40 preferably includes two resin-molded parts: a joiner body 42 primarily comprised of a relatively soft PP-EPDM-based TPO and a core 44 embedded within the joiner body 42 along the longitudinal direction. The joiner body 42 may include a head 42a that forms or defines the product surface that is visible from the outside when installed. A leg 42b may extend substantially perpendicularly toward the inside (deeper area) of the joiner 40 from the head 42a. A plurality of engagement fins 42c may extend from the leg 42b towards both sides and may be pressed against the sides of the building panels 60 when the joiner 40 is installed. The core 44 is preferably band-shaped and has a rectangular transversal cross section. Further, the core 44 is preferably embedded along the center of the leg 42b. These two resin-molded parts (the joiner body 42 and core 44) are positioned so as to overlap with each other (i.e., extend contiguously) along the longitudinal direction, and are thermally fused to each other.

The joiner body 42 is preferably composed primarily of a relatively soft PP-EPDM-based TPO. Further, the joiner body 42 preferably does not contain any fibrous filler or powder filler (expansion/contraction suppression component). On the other hand, the core 44 is preferably primarily comprised of a polypropylene resin and/or PP-EPDM-based TPO and also contains a fibrous filler primarily comprising carbon fibers at a weight percentage of between 1 and 10% of the total weight of the core 44 and a powder filler at the rate of 50% or less of the total weight of the core 44. In other words, the core 44 is a resin-molded part that is equivalent to a low-expansion/contraction resin molded part, which was described in further detail above.

As described above, the core 44 serves as a predetermined expansion/contraction suppression component (e.g., having a relatively low coefficient of linear expansion: e.g., between about 1×10⁻⁵ and 3×10⁻⁵/° C.). The joiner body 42 does not contain an expansion/contraction suppression component and preferably has a larger coefficient of linear expansion than the core 44 (e.g., greater than 5×10⁻⁵/° C.). However, when the joiner body 42 is integrated with the core 44, expansion and contraction of the joiner body 42 associated with temperature changes are suppressed, thereby improving the dimensional stability of the entire joiner 40 against temperature changes. Consequently, the joiner 40 will not deform, or will not substantially deform, when the temperature changes and can maintain itself appropriately installed between the building panels 60.

Furthermore, because the joiner 40 does not contain any metallic material, such as a metallic core, it is possible to adjust its length, etc. at a work site, etc. by easily cutting it using a simple cutting tool (i.e., without the use of a specialized tool). Naturally, the composite products of the above-described embodiments (i.e., the roof molding for automobiles and the joiner for building panels) can be manufactured using either of the above-described Methods (1) or (2). Also, in both the above-described roof molding and joiner embodiments, it is possible to vary the volume occupied by the core (low-expansion/contraction resin molded part) according to a required specification. For example, if the rigidity is insufficient in either of the above-described embodiments, the area excluding the thin-walled area (the fin-shaped areas extending to the right and left: see FIG. 3) of the engaging portion 16 in the roof molding 10 can be formed into a core, or the entire leg excluding the engagement fins 42c (see FIG. 4) in the joiner 40 can be formed into a core.

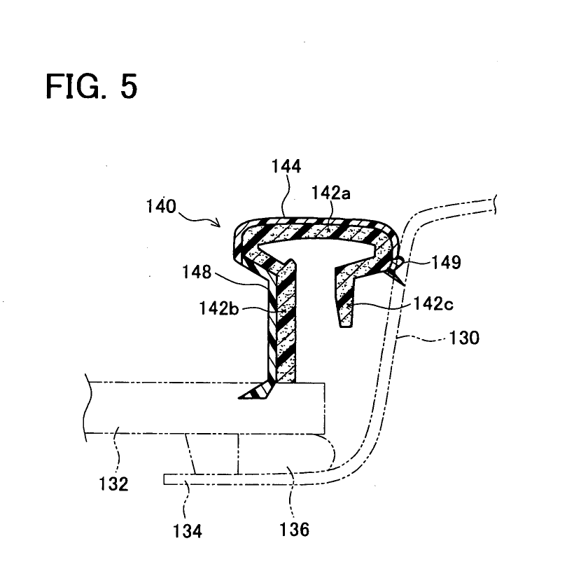

FIG. 5 shows another representative embodiment in which the composite product is utilized as a roof molding for automobiles. For example, a roof molding 140 may be installed along the boundary between the peripheral wall of a pillar panel 130 and a front window plate 132 using an installation clip (not shown). The space between the bottom flange 134 of the pillar panel 130 and the peripheral edge of the front window plate 132 is filled with a sealer/adhesive 136. The main body 142 of the roof molding 140 may include two legs 142b and 142c that extend downward from both sides of a head 142a around its bottom side. The installation clip (not shown) may be inserted between the legs 142b and 142c in order to install the roof molding 140 in the appropriate installation position (e.g., the peripheral wall of the pillar panel 130).

A decorative layer 144 may be formed on the surface of the head 142a. A side cover layer 148 may comprise a material that is more flexible than the main body 142 and may be disposed on the outside of the leg 142b. The bottom edge of the side cover layer 148 may extend in a lip shape beyond the leg 142b so as to elastically deform and tightly contact the surface of the front window plate 132. In addition, a shielding lip 149 may comprise a material that is more flexible than the main body 142 and acts as a cushioning material. The shielding lip 149 may be provided on one edge of the head 142a. These four resin-molded parts (the main body 142, decorative layer 144, side cover layer 148, and shielding lip 149) may be positioned so as to overlap with each other (i.e., extend contiguously) along the longitudinal direction. The decorative layer 144, the side cover layer 148, and the shielding lip 149 are each thermally fused to the main body 142, thereby integrating the four resin-molded parts. The decorative layer 144 and the side cover layer 148 are positioned on the product surface that is visible from the outside when the roof molding 140 is installed in the pillar panel. On the other hand, the main body 142 is located in a position that is not visible from the outside.

The main body 142 preferably substantially comprises a polypropylene resin and also contains a fibrous filler primarily comprising carbon fibers at a weight percentage of between 1 and 10% of the total weight of the main body 142 and a powder filler at a weight percentage of 50% or less of the total weight of the main body 142. In other words, this main body 142 is a resin-molded part that is equivalent to the low-expansion/contraction resin molded part that was described in further detail above. A preferred composition for the main body 142 includes a polypropylene resin, a PP-EPDM-based TPO, talc, and carbon fibers at the approximate ratio of 35.7:26.8:35:2.5 in terms of mass. A representative PP-EPDM-based TPO is available from Sunallomer Co., Ltd. under the product name Sunallomer-Catalloy™ KS-021P. Representative carbon fibers are available from Toho Rayon Co., Ltd. under the product name Besfight™ HTA-C6-N.

Furthermore, the decorative layer 144 may be a resin-molded part that primarily comprises colored polypropylene resin. For example, the decorative layer 144 can be manufactured using the product named QN620PD MEGY-D made by Apco Co., Ltd. The side cover layer 148 and the shielding lip 149 may be primarily comprised of a TPO (e.g., Milastomer™ C700BK made by Mitsui Chemicals) that does not contain any fibrous filler or powder filler, and these resin-molded parts are preferably more flexible than the main body 142. A roof molding having such a configuration can be manufactured, e.g., using an extrusion molding method that simultaneously extrudes the materials for these resin-molded parts.

The relationship between various compositions of the present resin moldings and their coefficients of linear expansion was evaluated. The materials used for manufacturing each resin molding and their abbreviations are listed below.

Polypropylene resin

PP: Product name “E-150GK” made by Idemitsu Petrochemical Co., Ltd. [Olefin-based thermoplastic elastomer]

TPO (1): Sunallomer-Catalloy™ KS-081P available from Sunallomer Co., Ltd., bending modulus of elasticity of147MPa (1,500kgf/cm²).

TPO (2): Sunallomer-Catalloy™ KS-021P available from Sunallomer Co., Ltd., bending modulus of elasticity of 265 MPa (2,700 kgf/cm²).

Fibrous fillers

Carbon fiber (1): Besfight™ HTA-C6-N made by Toho Rayon Co., Ltd., fiber length of 6 mm, average fiber diameter of 7 μm (PAN-based).

Carbon fiber (2): Torayca® T008 made by Toray Industries, Inc., fiber length of 6 mm, average fiber diameter of 7 μm (PAN-based).

Carbon fiber (3): Granoc™ XN-60C made by Nippon Graphite Fiber Corp., fiber length of 6 mm, average fiber diameter of 10 μm (pitch-based).

Carbon fiber (4): Dialead® K223HG made by Mitsubishi Chemical Products, Inc., fiber length of 6 mm, average fiber diameter of 10 μm (pitch-based).

Powder filler

Talc: Product name “PKP-80” made by Fuji Talc Industrial Co., Ltd.

The above-described materials were dry-blended according to the weight ratios (unit: % in weight) indicated for the embodiments and comparison examples shown in Tables 1 and 2. Examples 1 through 9 shown in Table 1 contain a polypropylene resin as the matrix resin, various types of carbon fibers as a fibrous filler, and talc as a powder filler. Examples 10 through 16 shown in Table 1 contain a TPO as the matrix resin, various types of carbon fibers as a fibrous filler, and talc as a powder filler. Examples 17 and 18 shown in Table 2 contain a polypropylene resin as the matrix resin and various types of carbon fibers as the fibrous filler, but do not contain any powder filler. The comparison example 1 shown in Table 1 contains a polypropylene resin as the matrix resin and talc as a powder filler, but does not contain any type of carbon fiber as a fibrous filler. These mixtures were kneaded in a kneading extruder, extruded into strands, and then made into pellets. The resulting pellets were placed in the hopper of an extrusion molder, heated and melted, and then extrusion-molded into a band that was 2-mm thick and 20-mm wide. This band was then cut into lengths of 1,000 mm and used as samples.

The coefficients of linear expansion were measured for these samples using the method described below. Tables 1 and 2 show the results. As a reference, Table 2 also shows the coefficient of linear expansion for iron (Fe).

Method for measuring the coefficient of linear expansion

(1) An elongated sample was cut into a length of 1,000 mm at room temperature (25° C.).

(2) The sample was set into a groove-shaped jig such that it could freely expand and contract.

(3) The length of the sample was measured at −30° C. after having been maintained at this temperature for 3 hours. This measurement result is noted as “1,000−α (mm).”

(4) The length of the sample was measured at +80° C. after having been maintained at this temperature for 3 hours. This measurement result is noted as “1,000+β (mm).”

(5) The coefficient of linear expansion was calculated using the formula shown below. Note that “110” in this formula is the temperature difference between the measurements performed in steps (3) and (4).

Coefficient of linear expansion=(α+β)/(1000×110)

TABLE 1

| | | | | | | | | | | Comparison |
|---|---|---|---|---|---|---|---|---|---|---|
| Unit: % | Examples | | | | | | | | | example |
| in weight | 1 | 2 | 3 | 4 | 5 | 6 | 7 | 8 | 9 | 1 |
| PP | 82.5 | 65.0 | 66.5 | 67.5 | 57.5 | 47.5 | 47.5 | 47.5 | 47.5 | 70.0 |
| Talc | 15.0 | 30.0 | 30.0 | 30.0 | 40.0 | 50.0 | 50.0 | 50.0 | 50.0 | 30.0 |
| Carbon | 2.5 | 5 | 3.5 | 2.5 | 2.5 | 2.5 | | | | |
| fiber (1) | | | | | | | | | | |
| Carbon | | | | | | | 2.5 | | | |
| fiber (2) | | | | | | | | | | |
| Carbon | | | | | | | | 2.5 | | |
| fiber (3) | | | | | | | | | | |
| Carbon | | | | | | | | | 2.5 | |
| fiber (4) | | | | | | | | | | |
| Coeffi- | 4.1 | 2.4 | 2.6 | 2.7 | 2.5 | 2.4 | 2.8 | 2.8 | 2.8 | 5.2 |
| cient of | | | | | | | | | | |
| linear | | | | | | | | | | |
| expan- | | | | | | | | | | |
| sion (× | | | | | | | | | | |
| 10⁻⁵/° C.) | | | | | | | | | | |

TABLE 2

| | | | | | | | | | | Comparison |
|---|---|---|---|---|---|---|---|---|---|---|
| | | | | | | | | | | example |
| Unit: % | Examples | | | | | | | | | (Fe) |
| in weight | 10 | 11 | 12 | 13 | 14 | 15 | 16 | 17 | 18 | 1 |
| PP | | | | | | | | 90.0 | 95.0 | |
| TPO (1) | 49.0 | 47.5 | 57.5 | 67.5 | | | | | | |
| TPO (2) | | | | | 69.0 | 67.5 | 65.0 | | | |
| Talc | 50.0 | 50.0 | 40.0 | 30.0 | 30.0 | 30.0 | 30.0 | | | |
| Carbon | 1.0 | 2.5 | 2.5 | 2.5 | 1.0 | 2.5 | 5 | 10.0 | 5.0 | |
| fiber (1) | | | | | | | | | | |
| Coeffi- | 2.1 | 1.6 | 2.4 | 2.7 | 2.9 | 2.7 | 2.1 | 1.3 | 3.9 | 1.4 |
| cient of | | | | | | | | | | |
| linear | | | | | | | | | | |
| expan- | | | | | | | | | | |
| sion (× | | | | | | | | | | |
| 10⁻⁵/° C.) | | | | | | | | | | |

As is clear from the above Tables 1 and 2, the resin moldings in Examples 1 through 18 all exhibited lower coefficients of linear expansion (5×10⁻⁵/° C. or lower) than Comparison example 1, which consisted of a polypropylene resin containing talc (powder filler) at a weight percentage of 30% in weight. For example, the resin moldings in Examples 2 through 4 and Examples 13, 15, and 16, which contain the same percentage of talc as Comparison example 1 (30% in weight) along with carbon fibers (fibrous filler) at a weight percentage of between 2.5 and 5% in weight, exhibited significantly lower coefficients of linear expansion, i.e., almost ½ of the coefficient of linear expansion of the resin molding in Comparison example 1. Although it is possible to obtain a resin molding exhibiting a low coefficient of linear expansion (e.g., 5×10⁻⁵/° C. or lower, or even 3×10⁻⁵/° C. or lower) without using talc (e.g., Examples 17 and 18), using talc along with carbon fibers can result in a resin molding exhibiting a lower coefficient of linear expansion at the same carbon fiber content (comparison between Examples 18 and 2). Alternatively, it is possible to obtain a resin molding exhibiting nearly the same coefficient of linear expansion using less carbon fiber (comparison between Examples 18 and 1).

In addition to the above-described examples, preferred compositions of the present resin moldings (low-expansion/contraction resin molded part) may contain TPO(1) at weight percentage of 62.5 in terms of mass, talc at a weight percentage of between 0 and 50 in terms of mass, and carbon fiber (1) at a weight percentage of between 1 and 5 in terms of mass. An especially preferable composition contains TPO(1), talc, and carbon fiber (1) at the mass ratio of 62.5:35:2.5 (mixing ratio).

The subject matter of the invention disclosed herein is considered to be:

(1) A composition of matter, comprising a mixture of:

a resin material comprising at least one of a polypropylene resin and an olefin-based thermoplastic elastomer,

a fibrous filler comprising carbon fibers as a primary component at a weight percentage of between about 1 and 10% of the total weight of the composition and

a powder filler at a weight percentage of between about 0 and 50% of the total weight of the composition;

(2) The composition of (1), wherein the powder filler comprises 35% or less of the total weight and the fibrous filler comprises at least 2.5% of the total weight of the composition;

(3) The composition of (1), wherein the composition has a coefficient of linear expansion equal to or less than 3×10⁻⁵/° C.;

(4) The composition of (1), wherein the composition has been extruded into an elongated shape;

(5) A composite product comprising the composition of (1) integrated or fused with at least one resin-molded part having a composition that is different from the composition of (1);

(6) The composite product of (5), wherein the composite product has an elongated shape and the composition of (1) is embedded within the at least one resin-molded part along a longitudinal direction of the composite product;

(7) The composite product of (6), wherein the at least one resin-molded part has a coefficient of linear expansion that is different from the composition of (1);

(8) The composite product of (7), wherein the coefficient of linear expansion of the composition of (1) is equal to or less than about 3×10⁻⁵/° C.;

(9) The composite product of (8), wherein the coefficient of linear expansion of the at least one resin-molded part is greater than 3×10⁻⁵/° C.;

(10) The composite product of (9), wherein the coefficient of linear expansion of the entire composite product is equal to or less than about 3×10⁻⁵/° C.;

(11) The composite product of (6), wherein the composite product is an elongated member that is arranged and constructed for installation along a metallic vehicle panel;

(12) The composite product of (11), wherein the composition of (1) is positioned in a location that is not visible from the outside when the elongated member is installed along the vehicle panel;

(13) The composite product of (11), wherein the at least one resin-molded part has a smooth surface and is positioned in a location that is visible from the outside when the elongated member is installed along the vehicle panel;

(14) The composite product of (6), wherein the composite product is an elongated member that is arranged and constructed for installation between building panels;

(15) The composite product of (14), wherein the elongated member is a joiner arranged and constructed for installation along a gap between peripheral edges of adjacently positioned building panels;

(16) The composite product of (5), wherein the composition of (1) contains the carbon fibers at a weight percentage of between 1 and 5% of the total weight of the composition of (1) and contains the powder filler at a weight percentage of between 10 and 35% of the total weight of the composition of (1);

(17) The composite product of (16), wherein the powder filler comprises talc;

(18) The composition of (1), wherein the powder filler comprises 35% or less of the total weight, the carbon fibers comprise at least 2.5% of the total weight of the composition and the composition has a coefficient of linear expansion equal to or less than 3×10⁻⁵/° C.;

(19) A composite product comprising the composition of (18) integrated or fused with at least one resin-molded part having a composition that is different from the composition of (18), wherein the composite product has an elongated shape, the composition of (18) is embedded within the at least one resin-molded part along a longitudinal direction of the composite product, the at least one resin-molded part has a coefficient of linear expansion that is greater than 3×10⁻⁵/° C. and the coefficient of linear expansion of the entire composite product is equal to or less than about 3×10⁻⁵/° C.;

(20) A resin molded product formed by mixing and molding:

a resin material comprising at least one of a polypropylene resin and an olefin-based thermoplastic elastomer,

carbon fibers at a weight percentage of between about 1 and 10% of the total weight of the resin molded product and

a powder filler at a weight percentage of between about 0 and 35% of the total weight of the resin molded product, wherein the resin molded product has a coefficient of linear expansion equal to or less than 3×10⁻⁵/° C.;

(21) The resin molded product of (20), wherein the powder filler comprises talc;

(22) A composition of matter comprising:

a resin material comprising at least one of a polypropylene resin and an olefin-based thermoplastic elastomer, the resin material having a coefficient of linear expansion that exceeds 3×10⁻⁵/° C., and

carbon fibers provided in an amount so that the composition of matter has a coefficient of linear expansion equal to or less than 3×10⁻⁵/° C.;

(23) The composition of (22), further comprising a powder filler in an amount so that the composition of matter has a coefficient of linear expansion equal to or less than 3×10⁻⁵/° C.;

(24) The composition of (23), wherein the powder filler is selected from the group consisting of calcium carbonate, calcium silicate, carbon black, talc, clay, kaolin, silica, diatomaceous earth, mica powder, alumina, barium sulfate, aluminum sulfate, calcium sulfate, basic magnesium carbonate, molybdenum disulfide, glass bulbs and Shirasu balloons.

(25) The composition of (23), wherein the powder filler is selected from the group consisting of talc, calcium carbonate and silica.

(26) The composition of (23), wherein the powder filler comprises talc.

(27) The composition of (24), wherein the coefficient of linear expansion of the composition of matter is between about 1×10⁻⁵/° C. and 3×10⁻⁵/° C.;

(28) A composite product comprising:

the composition of (27) fused to a resin material having a coefficient of linear expansion that exceeds 3×10⁻⁵/° C.;

(29) A composite product of (28), wherein composite product has an elongated shape and the coefficient of linear expansion of the entire composite product is less than 3×10⁻⁵/° C.;

(30) A composition of matter, comprising a mixture of:

a resin material comprising at least one of a polypropylene resin and an olefin-based thermoplastic elastomer,

carbon fibers at a weight percentage of between about 1 and 10% of the total weight of the composition and

a powder filler at a weight percentage of between about 0 and 50% of the total weight of the composition; and

(31) The composition of (30), wherein the powder filler comprises 35% or less of the total weight and the carbon fibers comprise at least 2.5% of the total weight of the composition.

Specific examples of the present invention were explained in detail above. However, these are merely examples and do not limit the scope of the claim. The techniques and compositions encompassed by the scope of the claim include various modifications and alterations thereof. Furthermore, the technical elements explained in this specification and/or the drawings demonstrate technical usefulness both alone and in various combinations, and are not limited to the combinations described in the claims.

1. A composite product comprising:
a composition of matter, comprising a mixture of:
a resin material comprising at least one of a polypropylene resin and an olefin-based thermoplastic elastomer,
a fibrous filler comprising carbon fibers as a primary component at a weight percentage of between about 1 and 10% of the total weight of the composition, and
a powder filler at a weight percentage of between about 0 and 50% of the total weight of the composition; and
at least one resin-molded part having a different composition from that of the composition of matter;
wherein the composition of matter is integrated or fused with the at least one resin-molded part.

2. A composite product according to claim 1, wherein the composite product has an elongated shape and the composition of matter is embedded within the at least one resin-molded part along a longitudinal direction of the composite product.

3. A composite product according to claim 2, wherein the at least one resin-molded part has a coefficient of linear expansion that is different from that of the composition of matter.

4. A composite product according to claim 3, wherein the coefficient of linear expansion of the composition of matter is equal to or less than about 3×10⁻⁵/° C.

5. A composite product according to claim 4, wherein the coefficient of linear expansion of the at least one resin-molded part is greater than 3×10⁻⁵/° C.

6. A composite product according to claim 5, wherein the coefficient of linear expansion of the entire composite product is equal to or less than about 3×10⁻⁵/° C.

7. A composite product according to claim 2, wherein the composite product is an elongated member that is arranged and constructed for installation along a metallic vehicle panel.

8. A composite product according to claim 7, wherein the composition of matter is positioned in a location that is not visible from the outside when the elongated member is installed along the vehicle panel.

9. A composite product according to claim 7, wherein the at least one resin-molded part has a smooth surface and is positioned in a location that is visible from the outside when the elongated member is installed along the vehicle panel.

10. A composite product according to claim 2, wherein the composite product is an elongated member that is arranged and constructed for installation between building panels.

11. A composite product according to claim 10, wherein the elongated member is a joiner arranged and constructed for installation along a gap between peripheral edges of adjacently positioned building panels.

12. A composite product according to claim 1, wherein the composition of matter contains the carbon fibers at a weight percentage of between 1 and 5% of the total weight of the composition of matter and contains the powder filler at a weight percentage of between 10 and 35% of the total weight of the composition of matter.

13. A composite product according to claim 12, wherein the powder filler comprises talc.

14. A composite product according to claim 1,
wherein the powder filler comprises 35% or less of the total weight of the composition of matter, the carbon fibers comprise at least 2.5% of the total weight of the composition of matter and the composition of matter has a coefficient of linear expansion equal to or less than 3×10⁻⁵/° C., and
wherein the composition of matter is integrated or fused with at least one resin-molded part having a different composition, wherein the composite product has an elongated shape, the composition of matter is embedded within the at least one resin-molded part along a longitudinal direction of the composite product, the at least one resin-molded part has a coefficient of linear expansion that is greater than 3×10⁻⁵/° C., and the coefficient of linear expansion of the entire composite product is equal to or less than about 3×10⁻⁵/° C.
